(19) United States
(12) Patent Application Publication
(10) Pub. No.: US 2017/0019480 A1
(43) Pub. Date: Jan. 19, 2017

(54) MOBILE DEVICE, VEHICLE REMOTE CONTROL SYSTEM, AND VEHICLE REMOTE CONTROL METHOD

(71) Applicant: Mitsubishi Electric Corporation, Tokyo (JP)

(72) Inventors: Hiroyuki YOKOTA, Kobe-shi (JP); Yoshihiro NAKAI, Kobe-shi (JP)

(73) Assignee: Mitsubishi Electric Corporation, Tokyo (JP)

(21) Appl. No.: 15/124,218

(22) PCT Filed: Apr. 10, 2014
(86) PCT No.: PCT/JP2014/060429

§ 371 Date: Sep. 7, 2016

(51) Int. Cl. H04L 29/08; B60R 25/20; E05B 81/56; B60R 25/25

(52) U.S. Cl. CPC H04L 67/12; B60R 25/257; B60R 25/209; B60R 25/2036; E05B 81/56

(57) ABSTRACT

Disclosed is a mobile device including a position information manager that stores, as the parking position, the position where a vehicle is keyed off, a voice recognition processor that is enabled and performs voice recognition of the user's utterance when the mobile device and vehicle-mounted equipment fall within an enabled distance range with respect to each other, and the communication controller that transmits a remote operation request on which voice recognition is performed by the enabled voice recognition processor to the vehicle-mounted equipment.

### FIELD OF THE INVENTION

The present invention relates to a mobile device for, a vehicle remote control system for, a vehicle remote control method of, and a non-transitory computer readable medium for storing a program for performing, in a vehicle, an operation which is requested in response to a remote operation request from a user.

### BACKGROUND OF THE INVENTION

In patent reference 1, a keyless entry system provided with a vehicle-mounted wireless terminal and a mobile wireless terminal is described. In this system, an ID request signal is transmitted from the vehicle-mounted wireless terminal to the mobile wireless terminal, and, when the vehicle-mounted wireless terminal verifies an ID sent back thereto from the mobile wireless terminal and this ID matches an ID which the vehicle-mounted wireless terminal has, electric power is supplied to a voice recognition processor of the vehicle. The voice recognition processor recognizes a voice which the user utters in the vicinity of the vehicle, and determines a key word. A controller of the vehicle extracts a command on the basis of the key word determined by the voice recognition processor, and operates the actuator of a door to perform locking or unlocking of the door according to the extracted command.

### RELATED ART DOCUMENT

### Patent Reference

Patent reference 1: Japanese Unexamined Patent Application Publication No. 2002-295086

### SUMMARY OF THE INVENTION

### Problems to be Solved by the Invention

In the system described in patent reference 1, an ID request from the vehicle-mounted wireless terminal to the mobile wireless terminal is made periodically, and, when the ID sent from the mobile wireless terminal matches the ID which the vehicle-mounted wireless terminal has, the electric power is supplied to the voice recognition processor. A problem with the conventional system is that communications are carried out periodically between both the terminals, as mentioned above, and therefore unnecessary communications occur until the ID verification is performed and the power consumption is large.

The present invention is made in order to solve the above-mentioned problem, and it is therefore an object of the present invention to provide a mobile device, a vehicle remote control system, a vehicle remote control method, and a non-transitory computer readable medium for storing a program capable of suppressing the occurrence of unnecessary communications, thereby being able to reduce the power consumption.

### Means for Solving the Problem

According to the present invention, there is provided a mobile device that transmits a remote operation request from a user to vehicle-mounted equipment and causes the vehicle-mounted equipment to perform an operation on a vehicle, the operation corresponding to the remote operation request, the mobile device including: a position information manager to store, as the parking position, the position where the vehicle is keyed off; a voice recognition processor to be enabled and perform voice recognition on the user's utterance when the mobile device and the vehicle-mounted equipment fall within an enabled distance range with respect to each other; and a communication controller to transmit the remote operation request on which voice recognition is performed by the enabled voice recognition processor to the vehicle-mounted equipment.

### Advantages of the Invention

According to the present invention, there is provided an advantage of being able to suppress the occurrence of unnecessary communications, thereby being able to reduce the power consumption.

### BRIEF DESCRIPTION OF THE FIGURES

FIG. 1 is a block diagram showing the configuration of a vehicle remote control system according to Embodiment 1 of the present invention;

FIG. 2 is a diagram showing an overview of a communication available area and a voice recognition enabled area in Embodiment 1;

FIG. 3 is a sequence of a process of acquiring a vehicle parking position and a vehicle state, which is performed by a mobile device according to Embodiment 1;

FIG. 4 is a flow chart of a process of enabling a voice recognition processor of the mobile device according to the distance between the mobile device and the vehicle in Embodiment 1;

FIG. 5A is a sequence of a vehicle remote operation according to Embodiment 1 (when the vehicle is in a state in which a request is made of the vehicle);

FIG. 5B is a sequence of a vehicle remote operation according to Embodiment 1 (when the vehicle is in a state in which no request is made of the vehicle);

FIG. 6 is a diagram showing an overview of a malfunction occurring when the voice recognition enabled area is fixed;

FIG. 7 is a diagram showing an overview of a process of changing a voice recognition enabled area (in a user's home) in Embodiment 2 of the present invention;

FIG. 8 is a diagram showing an overview of the process of changing the voice recognition enabled area (in a commercial facility) in Embodiment 2 of the present invention;

FIG. 9 is a diagram showing an example of a screen for setting the voice recognition enabled area corresponding to a point in Embodiment 2; and

FIG. 10 is a flow chart of the process of changing the voice recognition enabled area in Embodiment 2.

### EMBODIMENTS OF THE INVENTION

Hereafter, in order to explain this invention in greater detail, the preferred embodiments of the present invention will be described with reference to the accompanying drawings. Embodiment 1.

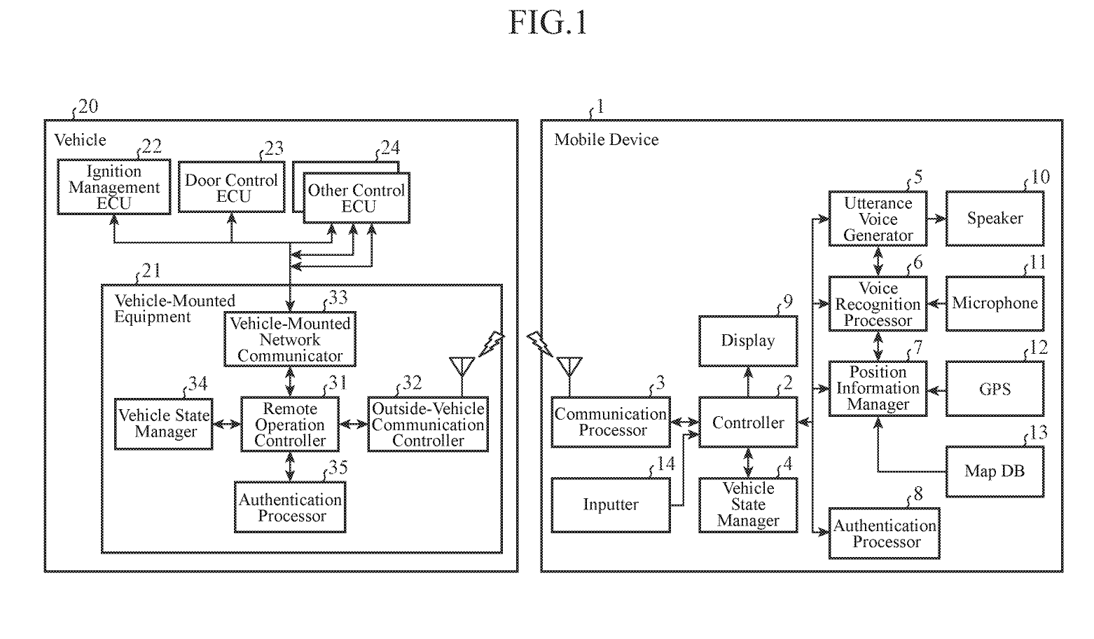

FIG. 1 is a block diagram showing the configuration of a vehicle remote control system according to Embodiment 1 of the present invention. The vehicle remote control system shown in FIG. 1 performs an operation on a vehicle, the operation corresponding to a remote operation request from a user (an operation of locking, unlocking, or opening or closing a door of the vehicle 20, or the like), and is configured with a mobile device 1, vehicle-mounted equipment 21, an ignition management ECU 22, a door control ECU 23 and other control ECUs 24.

The mobile device 1 is carried onto the vehicle 20 while being carried by a passenger. For example, the mobile device is implemented as a smart phone, a tablet PC, a mobile phone, or the like. The mobile device includes, as its components, a controller 2, a communication controller 3, a vehicle state manager 4, an utterance voice generator 5, a voice recognition processor 6, a position information manager 7, an authentication processor 8, a display 9, a speaker 10, a microphone 11, a GPS receiver 12, a map database (DB) 13 and an inputter 14.

The vehicle-mounted equipment 21 is mounted in the vehicle 20, and performs an operation on the vehicle 20, the operation corresponding to a remote operation request received from the mobile device 1. The vehicle-mounted equipment includes, as its components, a remote operation controller 31, an outside-vehicle communication controller 32, a vehicle-mounted network communicator 33, a vehicle state manager 34 and an authentication processor 35.

In the mobile device 1, the controller 2 controls each function of the mobile device 1.

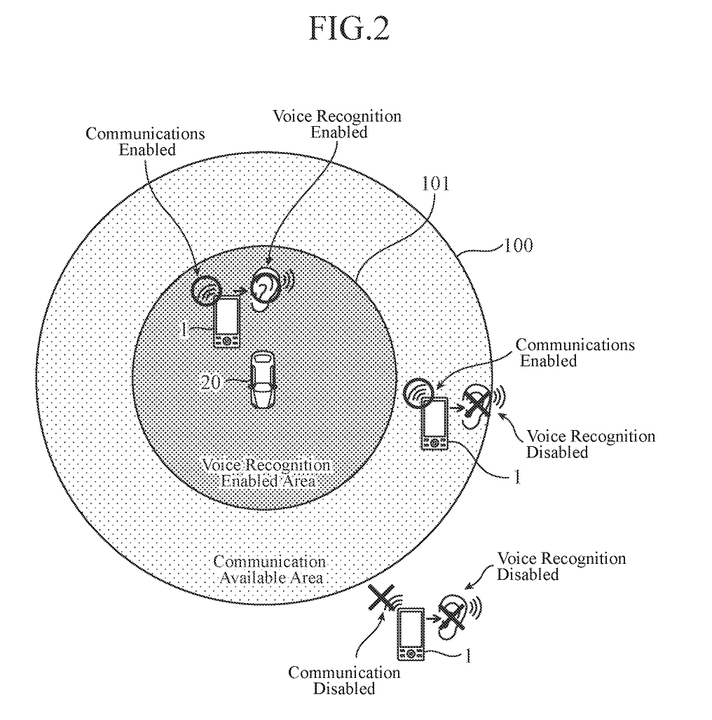

The communication controller 3 is enabled and communicates with the vehicle-mounted equipment 21 when the mobile device enters a communication available area, which will be described later by referring to FIG. 2. For example, the communication controller transmits a remote operation request on which voice recognition has been performed by the voice recognition processor 6 to the vehicle-mounted equipment. As the communications, for example, short-range wireless communications, such as Bluetooth (registered trademark; this description will be omitted hereafter), a wireless LAN, or communications using infrared light, are used.

The vehicle state manager 4 manages the state of the vehicle 20, information about the state being received from the vehicle-mounted equipment 21 via the communication controller 3. For example, the current state showing whether a door of the vehicle 20 is locked or unlocked, or open or closed is managed. The utterance voice generator 5 generates voice data which is used for one of various notifications to the user. For example, when the current state of the vehicle 20 is already in a state corresponding to the operation which is the target for a remote operation request made by the user, the utterance voice generator generates voice data “Already in the requested state”, and outputs this voice from the speaker 10.

The voice recognition processor 6 is enabled and performs voice recognition on the user's utterance when the mobile device 1 and the vehicle-mounted equipment 21 fall within an enabled distance range with respect to each other. The enabling of the voice recognition processor 6 shows that, for example, the voice recognition processor enters a state in which the supply of electric power to the voice recognition processor 6 is started and the voice recognition processor consumes the electric power supplied thereto to be able to operate. Further, the enabled distance range is determined with respect to the position of the vehicle-mounted equipment 21, and, when the mobile device 1 exists within this enabled distance range, the voice recognition processor 6 is enabled. Even if the mobile device 1 is located in the communication available area mentioned above, the voice recognition processor 6 is not enabled when the mobile device is not located in the voice recognition enabled area.

The position information manager 7 determines the position of the mobile device 1 on the basis of the GPS information inputted thereto from the GPS (Global Positioning System) receiver 12, and stores, as the parking position of the vehicle 20, the position where the vehicle 20 has been keyed off. Here, keying off the vehicle 20 is an operation of stopping driving the vehicle 20. For example, switching off the ignition is cited as the operation. When the vehicle 20 is an electric one, the keying off is an operation of switching off the power supply of the driving system.

The authentication processor 8 acquires the authentication information about the user of the mobile device 1, and performs a process of authenticating the user between the mobile device and the vehicle-mounted equipment 21.

The display 9 is disposed in the mobile device 1, and displays, for example, a setting screen for accepting a setting input from the user. The speaker 10 is a voice outputter that outputs the voice data generated by the utterance voice generator 5. The microphone 11 captures a voice, and, for example, receives a remote operation request made by the user using a voice.

The GPS receiver 12 receives the GPS information from GPS satellites. The map DB 13 is a database in which pieces of map information are registered, and has POI (Point Of Interest) information as map information. The input unit 14 accepts the user's input of information, and, for example, accepts information inputted using a touch panel, hardware keys, or the like.

The controller 2, the communication controller 3, the vehicle state manager 4, the utterance voice generator 5, the voice recognition processor 6, the position information manager 7 and the authentication processor 8 are implemented as concrete units in each of which hardware and software work in cooperation with each other, by, for example, causing a computer to execute a program in which the features of the invention according to this Embodiment 1 are described.

The ignition management ECU 22 is mounted in the vehicle 20 and manages the state of the ignition. The door control ECU 23 performs door control on the vehicle 20. The other control ECUs 24 control various processes other than those on the ignition and the doors in the vehicle 20.

In the vehicle-mounted equipment 21, the remote operation controller 31 controls an operation on the vehicle 20, the operation corresponding to the remote operation request received from the mobile device 1 via the outside-vehicle communication controller 32. The outside-vehicle communication controller 32 controls communications with the mobile device 1, and receives the user's remote operation request transmitted from the mobile device 1. As the communications performed by the outside-vehicle communication controller 32, for example, short-range wireless communications, such as Bluetooth, a wireless LAN, or communications using infrared light, are used.

The vehicle-mounted network communicator 33 communicates with the ignition management ECU 22, the door control ECU 23, and the other control ECUs 24 via a vehicle-mounted network such as CAN (Control Area Network), to receive various pieces of information. The vehicle state manager 34 manages the state of the vehicle 20, information about the state being received, via the vehicle-mounted network communicator 33, from the ignition management ECU 22, the door control ECU 23 and the other control ECUs 24. The authentication processor 35 performs the process of authenticating the user by using the authentication information which the outside-vehicle communication controller 32 receives from the mobile device 1.

The remote operation controller 31, the outside-vehicle communication controller 32, the vehicle-mounted network communicator 33, the vehicle state manager 34 and the authentication processor 35 are implemented as concrete units in each of which hardware and software work in cooperation with each other, by, for example, causing a computer to execute a program in which the features of the invention according to this Embodiment 1 are described.

FIG. 2 is a diagram showing an overview of the communication available area 100 and the voice recognition enabled area 101 in Embodiment 1. Referring to FIG. 2, the communication available area 100 is a distance range which is determined with respect to the position of the vehicle-mounted equipment 21, and, when the mobile device 1 is located within the communication available area 100, the communication controller 3 is enabled. Here, the enabling of the communication controller 3 shows that the communication controller 3 is set to a state in which the communication controller can communicate with the outside-vehicle communication controllers 32 of the vehicle-mounted equipment 21.

The voice recognition enabled area 101 is an enabled distance range which is determined with respect to the position of the vehicle-mounted equipment 21 (the parking position of the vehicle 20), and, when the mobile device 1 is located within this range, the voice recognition processor 6 of the mobile device 1 is enabled. The position information manager 7 of the mobile device 1 compares the current position of the mobile device 1, which is specified on the basis of the GPS information from the GPS receiver 12, with the position (parking position) of the vehicle 20 which was stored when the vehicle 20 was last keyed off, to determine whether the mobile device 1 is located in either the communication available area 100 or the voice recognition enabled area 101.

When the mobile device 1 is located in neither the communication available area 100 nor the voice recognition enabled area 101, the communications, by the communication controller 3, with the vehicle-mounted equipment 21 are disabled, and the voice recognition processor 6 is also disabled, so that the recognition of utterance cannot be carried out. When the mobile device 1 is located in the communication available area 100, but is not located in the voice recognition enabled area 101, the communications, by the communication controller 3, with the vehicle-mounted equipment 21 are enabled, but the voice recognition processor 6 is disabled. When the mobile device 1 is located in both the communication available area 100 and the voice recognition enabled area 101, the communications with the vehicle-mounted equipment 21 are enabled and the voice recognition processor 6 is also enabled.

Next, operations will be explained.

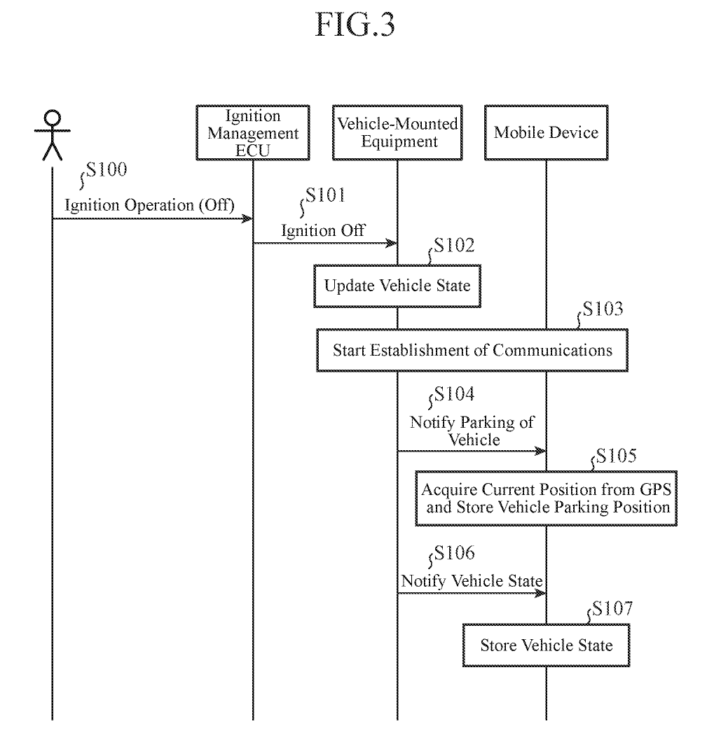

FIG. 3 shows the sequence of the process of acquiring the parking position and the vehicle state of the vehicle 20, which is performed by the mobile device 1 according to Embodiment 1. As a premise for the process shown in FIG. 3, it is assumed that the mobile device 1 is carried into the vehicle 20 by the user, and the vehicle 20 then moves in this state.

First, in a state S100, the user performs an operation of switching off the ignition in order to stop driving the vehicle 20 (park the vehicle 20).

The ignition management ECU 22 detects the ignition operation and notifies the vehicle-mounted network communicator 33 via the vehicle-mounted network that the ignition has been switched off (state S101). The vehicle-mounted network communicator 33 outputs the information notified from the ignition management ECU 22 to the vehicle state manager 34. The vehicle state manager 34 then updates the vehicle state of the vehicle 20 by using the vehicle state information (ignition off) inputted from the vehicle-mounted network communicator 33 (state S102).

The outside-vehicle communication controller 32 starts establishment of communications with the mobile device 1 when triggered by the ignition off (state S103). At this time, the authentication processor 35 connects with the authentication processor 8 of the mobile device 1 to receive the authentication information, and performs the process of authenticating the user. When the user is authenticated, communications are established between the mobile device 1 and the vehicle-mounted equipment 21.

When receiving the notification of the parking (ignition off) of the vehicle 20 from the vehicle-mounted equipment 21 (state S104), the communication controller 3 of the mobile device 1 outputs a notification showing the parking to the controller 2. The controller 2 outputs a notification showing that the vehicle 20 has been parked to the vehicle state manager 4 and the position information manager 7.

The position information manager 7 acquires the current position from the GPS information from the GPS receiver 12 when triggered by the parking (ignition off) of the vehicle 20, and stores this position as the parking position of the vehicle 20 (state S105).

Next, the outside-vehicle communication controller 32 of the vehicle-mounted equipment 21 notifies the current vehicle state of the vehicle 20 which the vehicle state manager 34 manages to the mobile device 1, in accordance with a command from the remote operation controller 31 (state S106). The vehicle state notified at this time is the state of the vehicle 20 which is the target for remote operations. For example, the vehicle state is the current state showing the locking, the unlocking, the opening or closing, or the like of a door. The vehicle state manager 4 of the mobile device 1 stores the vehicle state, information about the vehicle state being received by the communication controller 3, in accordance with a command from the controller 2 (state S107). By doing in this way, the mobile device can automatically store the position (parking position) of the vehicle 20 without requiring any user operation.

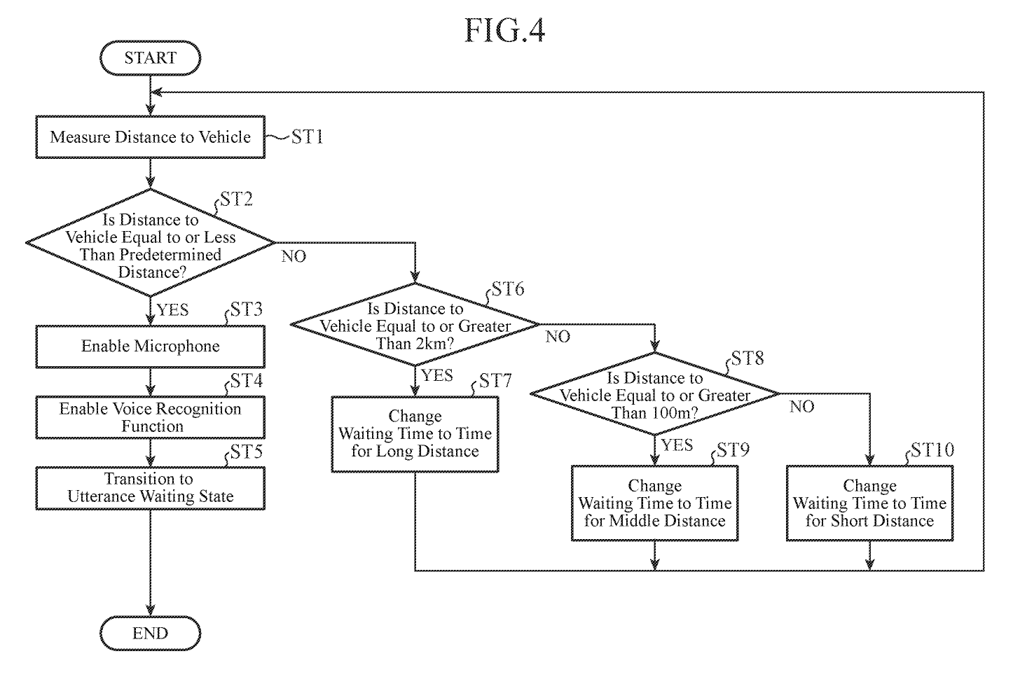

FIG. 4 is a flow chart of the process according to Embodiment 1 of enabling the voice recognition processor 6 of the mobile device 1 according to the distance to the vehicle 20, and shows a case in which the user carrying the mobile device 1 leaves the vehicle 20 and then moves after parking the vehicle 20.

The position information manager 7 of the mobile device 1 measures the distance between the mobile device 1 and the parking position of the vehicle 20 on the basis of both the parking position stored at the time that the vehicle 20 was last parked, and the current position of the mobile device 1 acquired from the GPS information of the GPS receiver 12 (step ST1). The period of this measurement can be changed according to the distance between the parking position of the vehicle 20 and the current position of the mobile device 1.

The position information manager 7 determines whether or not the distance between the parking position of the vehicle 20 and the current position of the mobile device 1 is equal to or less than a fixed distance which is determined in advance (step ST2). The fixed distance is one (enabled distance) at which the voice recognition processor 6 of the mobile device 1 should be enabled. For example, the fixed distance is 30 m.

When the mobile device 1 is at the fixed distance or less to the parking position of the vehicle 20 (when YES in step ST2), the position information manager 7 enables the microphone 11 (in a state in which the microphone can collect a sound) via the voice recognition processor 6 (step ST3), and then enables the voice recognition processor 6 (step ST4). As a result, the voice recognition processor 6 enters a state of waiting for an utterance from the user (step ST5).

In contrast, when the distance between the current position of the mobile device 1 and the parking position of the vehicle 20 exceeds the fixed distance (when NO in step ST2), the position information manager 7 determines whether or not the distance between the current position of the mobile device 1 and the parking position of the vehicle 20 is equal to or greater than 2 km (step ST6).

When the distance between the current position of the mobile device 1 and the parking position of the vehicle 20 is equal to or greater than 2 km (when YES in step ST6), the position information manager 7 changes the waiting time during which the position information manager waits for itself to judge the distance between the position of the mobile device 1 and the parking position of the vehicle 20 the next time to a time for long distances (step ST7). The time for long distances is a waiting time which is sufficiently long enough to judge the distance the next time. For example, the time for long distances is 10 minutes. After that, the position information manager returns to the process of step ST1.

When the distance between the current position of the mobile device 1 and the parking position of the vehicle 20 is less than 2 km (when NO in step ST2), the position information manager 7 determines whether or not the distance between the current position of the mobile device 1 and the parking position of the vehicle 20 is equal to or greater than 100 m (step ST8).

When the distance between the current position of the mobile device 1 and the parking position of the vehicle 20 is equal to or greater than 100 m (when YES in step ST8), the position information manager 7 changes the waiting time during which the position information manager waits for itself to judge the distance between the position of the mobile device 1 and the parking position of the vehicle 20 the next time to a time for middle distances (step ST9). The time for middle distances is shorter than the time for long distances, and is sufficiently long enough to judge the distance the next time. For example, the time for middle distances is 1 minute. After that, the position information manager returns to the process of step ST1.

When the distance of the current position of the mobile device 1 and the parking position of the vehicle 20 is less than 100 m (when NO in step ST8), the position information manager 7 changes the waiting time during which the position information manager waits for itself to judge the distance between the position of the mobile device 1 and the parking position of the vehicle 20 the next time to a time for short distances (step ST10). Because the time for short distances is a waiting time set when the mobile device 1 is close to the parking position of the vehicle 20, and it is necessary to judge the distance frequently when the mobile device is close to the parking position, the time for short distances is sufficiently short. For example, the time for short distances is 5 seconds. After that, the position information manager returns to the process of step ST1.

Because by changing the period of the judgement of the distance according to the distance between the mobile device 1 and the vehicle 20 in this way, the necessity to enable the voice recognition processor 6 at all times can be eliminated, the power consumption of the mobile device 1 can be suppressed. Further, when the distance between the mobile device 1 and the vehicle 20 is equal to or greater than a fixed distance, the voice recognition processor 6 is disabled. Therefore, a wrong operation on the vehicle 20 and unnecessary communications with the vehicle 20 because of incorrectly-performed voice recognition can be prevented and the power consumption of the vehicle 20 can also be suppressed.

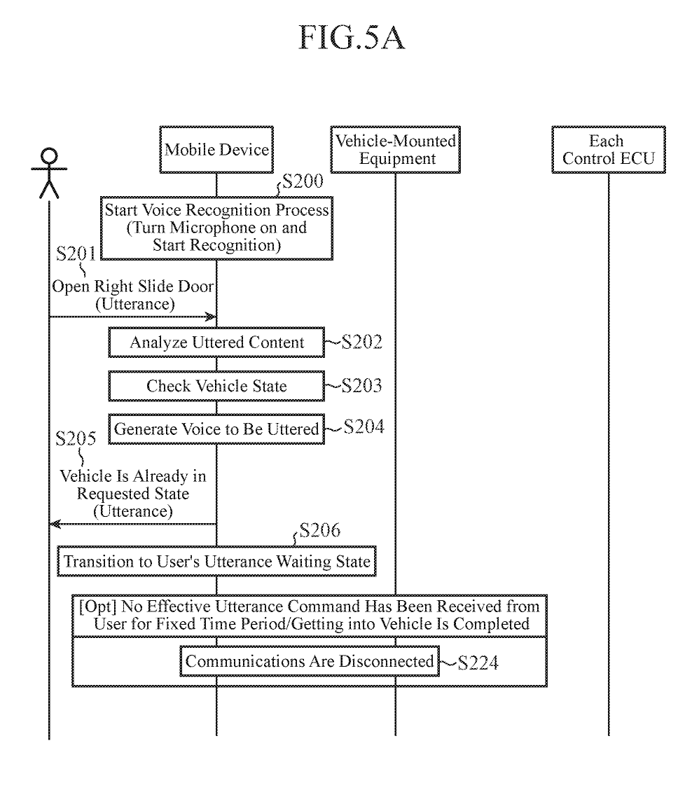

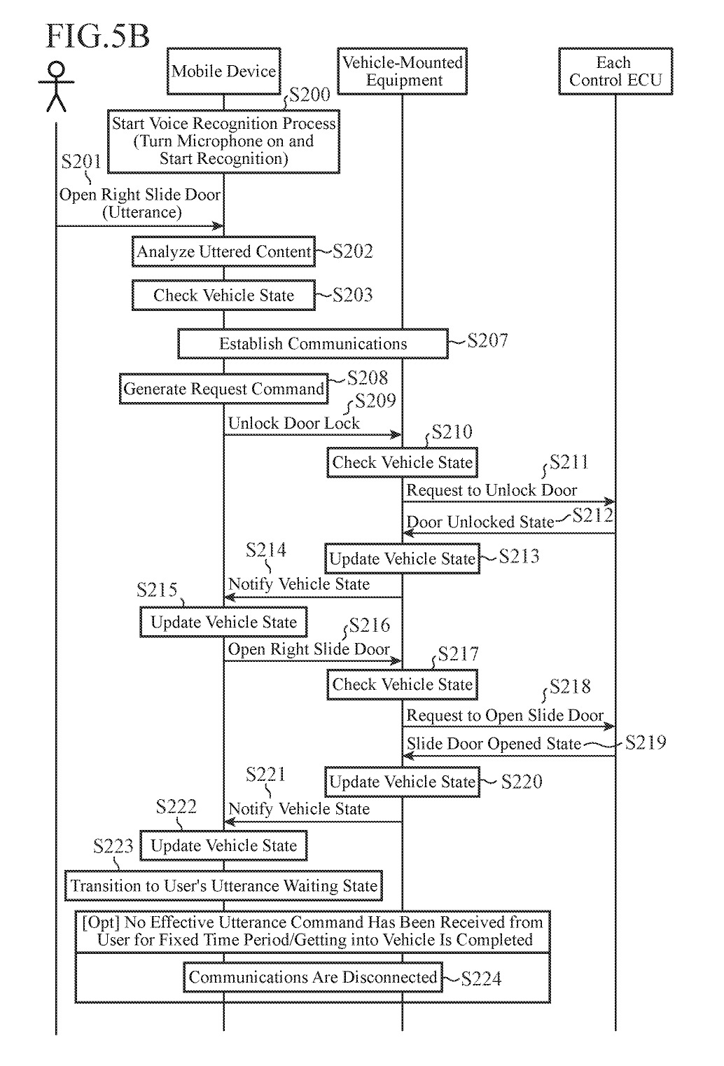

FIG. 5A shows the sequence of a vehicle remote operation according to Embodiment 1, and shows a case in which the vehicle 20 is already in a requested state corresponding to a remote operation request. FIG. 5A also shows a series of processes after the mobile device has made a transition to the utterance waiting state of step ST5 shown in FIG. 4. More specifically, the voice recognition processor 6 of the mobile device 1 starts voice recognition by bringing the microphone 11 to the ON state (state S200).

Here, it is assumed that in a state S201, the user utters, for example, “Open the right slide door.”

The voice recognition processor 6 performs voice recognition on the above-mentioned utterance collected by the microphone 11, and the vehicle state manager 4 analyzes the contents of the utterance (state S202). In this case, the voice recognition processor 6 recognizes that a remote operation request “Open the right slide door” has been made, and the vehicle state manager 4 determines that the following two remote operation requests: a request to unlock the right slide door and a request to open the right slide door have been made by using a single utterance. After that, the vehicle state manager 4 compares a vehicle state expected from those utterance contents with the current vehicle state notified thereto in advance from the vehicle-mounted equipment 21, to check whether or not the current vehicle state corresponds to a vehicle state after the operation which is the target for the remote operation request made by the user (state S203).

FIG. 5A shows the case in which the vehicle 20 is already in the requested state corresponding to the remote operation request. More specifically, it is assumed that the right slide door of the vehicle 20 is already open. At this time, the utterance voice generator 5 generates voice data showing that the vehicle 20 is already in the requested state corresponding to the remote operation request (state S204). For example, voice data “Already in the requested state” is generated and outputted (uttered) from the speaker 10 (state S205).

After that, the voice recognition processor 6 makes a transition to the state of waiting for an utterance from the user (state S206). When the voice recognition processor cannot recognize an effective utterance from the user (a remote operation request from the user) even after a fixed time (e.g., about 1 minute) has elapsed since the voice recognition processor last entered the state S206 or when the user gets into the vehicle 20, the voice recognition processor can make a transition to a state S224 and disconnect the communications with the vehicle-mounted equipment 21.

Thus, when the current vehicle state corresponds to a vehicle state after the operation which is the target for the remote operation request made by the user, the mobile device 1 notifies the user, by voice, to that effect without communicating with the vehicle-mounted equipment 21. As a result, the power consumption by the communications between the mobile device 1 and the vehicle-mounted equipment 21 can be suppressed.

FIG. 5B shows the sequence of a vehicle remote operation according to Embodiment 1, and shows a case in which the vehicle 20 is not in the requested state. Processes in states S200 to S202 are the same as those shown in FIG. 5A. When the voice recognition processor 6, in a state S203, analyzes that the remote operation request is “Open the right slide door”, the vehicle state manager 4 makes a comparison with the current vehicle state notified from the vehicle-mounted equipment 21, and confirms that the current vehicle state does not yet correspond to a vehicle state after the operation which is the target for the remote operation request made by the user.

The communication controller 3 starts communications with the vehicle-mounted equipment 21 when triggered by the information showing that the vehicle 20 is not in a vehicle state after the operation which is the target for the remote operation request and the voice recognition processor 6 has voice-recognized the effective remote operation request (state S207). The authentication processor 8 of the mobile device 1 connects with the authentication processor 35 of the vehicle-mounted equipment 21 and transmits the authentication information, and performs the process of authenticating the user. When the user is authenticated, communications are established between the mobile device 1 and the vehicle-mounted equipment 21.

Because the utterance of the remote operation request is “Open the right slide door”, the controller 2 generates a request command to make a request to unlock the right slide door first, and then generates a request command to make a request to open the right slide door (state S208). After that, the controller 2 transmits the request command to make a request to unlock the right slide door to the vehicle-mounted equipment 21 via the communication controller 3 (state S209).

The vehicle state manager 34 of the vehicle-mounted equipment 21 checks the current state of the vehicle 20 which the vehicle state manager manages in advance (the unlocked or locked state of the right slide door) (state S210). When the right slide door is not unlocked, the remote operation controller 31 transmits the request command received from the mobile device 1 (the request to unlock the right slide door) to the door control ECU 23 via the vehicle-mounted network communicator 33 (state S211).

When receiving the remote operation request command (the request to unlock the right slide door), the door control ECU 23 unlocks the right slide door and sends a notification showing that the slide door has been unlocked to the remote operation controller 31 via the vehicle-mounted network communicator 33 (state S212). The remote operation controller 31 notifies the vehicle state manager 34 that the right slide door has been unlocked, and the vehicle state manager 34 updates the current state of the vehicle 20 on the basis of the contents of the notification from the remote operation controller 31 (state S213). The remote operation controller 31 also commands the outside-vehicle communication controller 32 to notify the mobile device 1 that the right slide door has been unlocked (state S214).

The vehicle state manager 4 of the mobile device 1 updates the current state of the vehicle 20 which the vehicle state manager itself manages by using the vehicle state (showing that the right slide door has been unlocked) notified from the vehicle-mounted equipment 21 (state S215). The controller 2 then transmits the request command to make a request to open the right slide door to the vehicle-mounted equipment 21 via the communication controller 3 (state S216).

The vehicle state manager 34 of the vehicle-mounted equipment 21 checks the current state of the vehicle 20 which the vehicle state manager manages in advance (the open or closed state of the right slide door) (state S217). When the right slide door is not open, the remote operation controller 31 transmits the request command received from the mobile device 1 (the request to open the right slide door) to the door control ECU 23 via the vehicle-mounted network communicator 33 (state S218).

When receiving the remote operation request command (the request to open the right slide door), the door control ECU 23 opens the right slide door and sends a notification showing that the slide door is in the opened state to the remote operation controller 31 via the vehicle-mounted network communicator 33 (state S219).

The remote operation controller 31 notifies the vehicle state manager 34 that the right slide door is in the opened state, and the vehicle state manager 34 updates the current state of the vehicle 20 on the basis of the notification contents from the remote operation controller 31 (state S220). Next, the remote operation controller 31 commands the outside-vehicle communication controller 32 to notify the mobile device 1 that the right slide door has been opened (state S221).

The vehicle state manager 4 of the mobile device 1 updates the current state of the vehicle 20 which the vehicle state manager itself managed by using the vehicle state (showing that the right slide door has been opened) notified from the vehicle-mounted equipment 21 (state S222). After that, the voice recognition processor 6 makes a transition to the state of waiting for an utterance from the user (state S223). Like in the case shown in FIG. 5A, when the voice recognition processor cannot recognize an effective utterance from the user (a remote operation request from the user) even after a fixed time (e.g., about 1 minute) has elapsed since the voice recognition processor last entered the state S223 or when the user gets into the vehicle 20, the voice recognition processor can make a transition to a state S224 and disconnect the communications with the vehicle-mounted equipment 21.

As mentioned above, the mobile device according to this Embodiment 1 includes the position information manager 7 that stores, as the parking position, the position where the vehicle 20 is keyed off, the voice recognition processor 6 that is enabled and performs voice recognition on the user's utterance when the mobile device 1 and the vehicle-mounted equipment 21 fall within the enabled distance range with respect to each other, and the communication controller 3 that transmits a remote operation request on which voice recognition is performed by the enabled voice recognition processor 6 to the vehicle-mounted equipment 21.

Because the mobile device is configured in this way, even if the mobile device 1 and the vehicle-mounted equipment 21 fall within the communication available range with respect to each other, the voice recognition processor 6 is not enabled until the mobile device and the vehicle-mounted equipment fall within the enabled distance range with respect to each other, and the communication controller 3 transmits the remote operation request, on which the voice recognition is performed by the voice recognition processor 6 which is enabled when the mobile device 1 enters the enabled distance range, to the vehicle-mounted equipment 21. More specifically, because the communications between the mobile device 1 and the vehicle-mounted equipment 21 are suppressed until the communication controller transmits the remote operation request which the enabled voice recognition processor 6 has recognized to the vehicle-mounted equipment 21, the power consumption of the mobile device 1 and that of the vehicle-mounted equipment 21 can be reduced.

In the system described in patent reference 1, periodic communications are performed until ID verification is performed. In contrast with this, because according to the present invention, by setting the enabled distance range in which the voice recognition processor 6 is enabled, the necessity to perform periodic communications is eliminated and communications between the mobile device 1 and the vehicle-mounted equipment 21 do not occur until the voice recognition processor 6 is enabled, the present embodiment can provide a great reduction in the power consumption over the conventional system.

Further, according to this Embodiment 1, the communication controller 3 starts communications with the vehicle-mounted equipment 21 when triggered by information showing that the voice recognition processor 6 has performed voice recognition on a remote operation request.

Because the mobile device 1 and the vehicle-mounted equipment 21 do not continue communicating with each other at all times, and do not start communications with each other until the voice recognition processor 6 is enabled and the enabled voice recognition processor 6 then performs voice recognition on a remote operation request, as mentioned above, the occurrence of unnecessary communications can be suppressed and the power consumption can be reduced.

### Embodiment 2

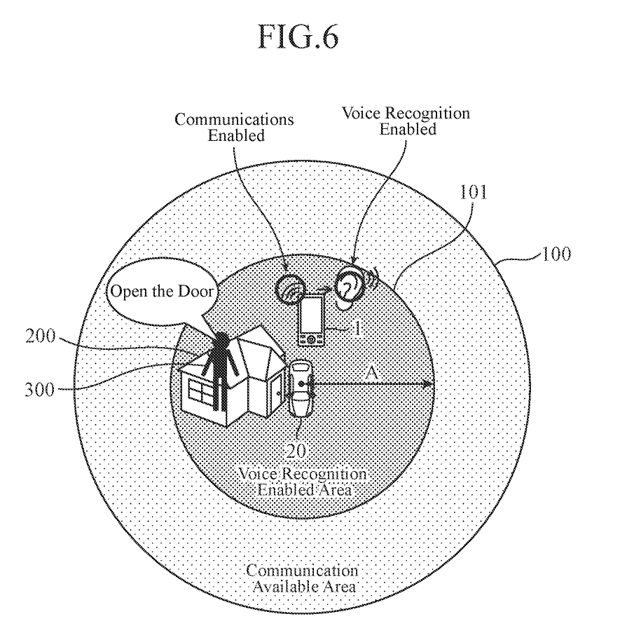

In Embodiment 1, as shown in FIG. 6, when the distance between the parking position of the vehicle 20 and the current position of the mobile device 1 falls within a fixed distance (enabled distance) A, the voice recognition processor 6 is enabled.

In this case, when the user's home is close to the parking place, because the mobile device 1 and the vehicle-mounted equipment 21 exist at the enabled distance A or less with respect to each other even if the user 300 is at the user's home 200, the voice recognition processor 6 is enabled at all times. At this time, when the user 300 utters “Open the door” in order to open the door of the user's home 200, the voice recognition processor 6 of the mobile device 1 may misrecognize the utterance as a remote operation request made of the vehicle 20. Further, when the voice recognition processor 6 is enabled, the power consumption of the mobile device 1 also increases.

In Embodiment 2, in order to resolve the above-mentioned malfunction, the above-mentioned enabled distance at which the voice recognition processor 6 of the mobile device 1 is enabled is caused to be variable.

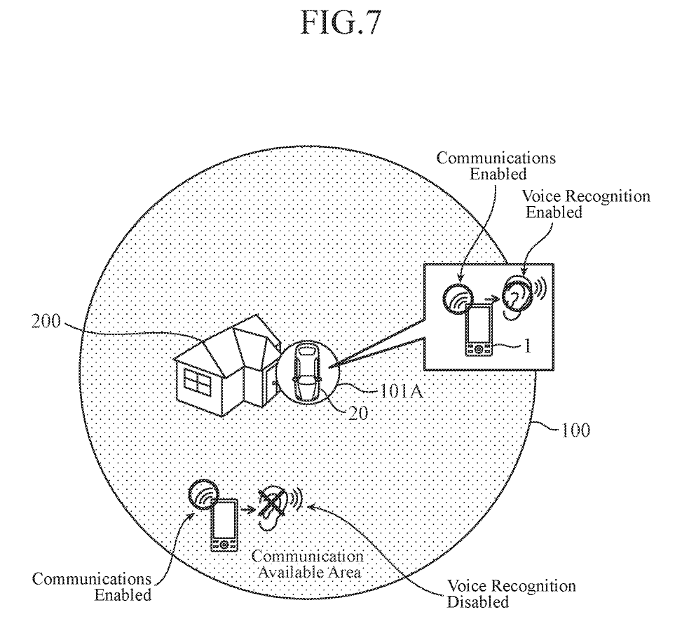

For example, when the parking position is a restricted point which is determined in advance, the position information manager 7 of the mobile device 1 reduces the enabled distance range. When the restricted point is the user's home, as shown in FIG. 7, where its parking place is disposed closely, the position information manager shortens the enabled distance to a value less than a normal one, to set a voice recognition enabled area 101A (e.g., an area having a radius of 3 m). A restricted point is one at which the range in which the voice recognition processor 6 is enabled is restricted to a range smaller than a normal one, and is preset by the user and stored in the position information manager 7 or the map DB 13. The position information manager 7 carries out the determination of whether or not the current position is a restricted point by making a comparison between the current position and the position which is preset as the restricted point.

In contrast, there is a case in which it is more convenient to enlarge the range in which the voice recognition processor 6 is enabled when the parking position of the vehicle 20 is in a facility which is specified in advance.

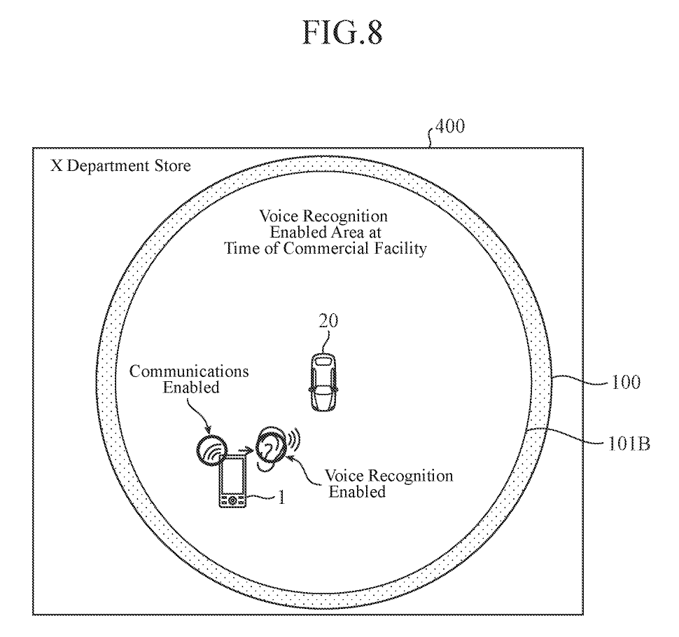

More specifically, when the parking position is an allowable point which is determined in advance, the position information manager 7 of the mobile device 1 enlarges the enabled distance range. For example, when the allowable point is in a commercial facility having a wide parking place as shown in FIG. 8, the position information manager enlarges the enabled distance to a value greater than the normal one to set a voice recognition enabled area 101B (e.g., an area having a radius of 30 m). An allowable point is one at which the range in which the voice recognition processor 6 is enabled is allowed to become larger than the normal one, and is preset by the user and stored in the position information manager 7 or the map DB 13. The position information manager 7 carries out the determination of whether or not the current position is a restricted point by making a comparison between the current position and the position which is preset as the allowable point. As a result, also when the user's child runs ahead in the parking place of a commercial facility or the like to get into the vehicle 20, the user is enabled to cause the vehicle 20 to perform an operation of opening or closing the doors thereof from a distant place.

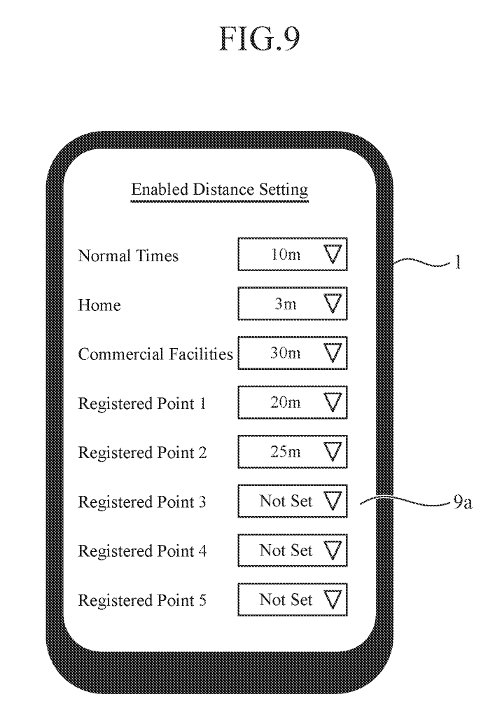

Further, the position information manager 7 can change the enabled distance range to a distance range specified by the user. For example, the position information manager 7 displays a setting screen 9a for setting enabled distances, as shown in FIG. 9, on a display 9 under the control by the controller 2, and accepts an input of the enabled distance corresponding to each point. The position information manager 7 registers, as an enabled distance, the distance accepted from the user while linking the distance with the corresponding point.

For commercial facilities, the position information manager 7 determines the enabled distance by making a comparison between map data read from the map DB 13 and the current position of the vehicle 20. Further, the position information manager stores the enabled distances for the user's home and registered points which the user set separately, other than commercial facilities, while linking position information about each of them (coordinates specified from GPS information or an address inputted by the user) with an enabled distance. By causing the user to set the enabled distance corresponding to each point in this way, the convenience of the device is improved. In addition, enabled distances can be set for each user.

Further, the position information manager 7 can automatically change the enabled distance range. For example, on the basis of the current position information acquired from the GPS information provided by the GPS receiver 12 and the POI information read from the map DB 13, the position information manager 7 automatically changes the enabled distance range.

The position information manager can be configured in such a way as to perform this changing process after the mobile device 1 performs the process of acquiring the distance to the vehicle 20, or in such a way as to perform the changing process in advance when the user last parked the vehicle 20 because the vehicle position is decided when the user parks the vehicle 20.

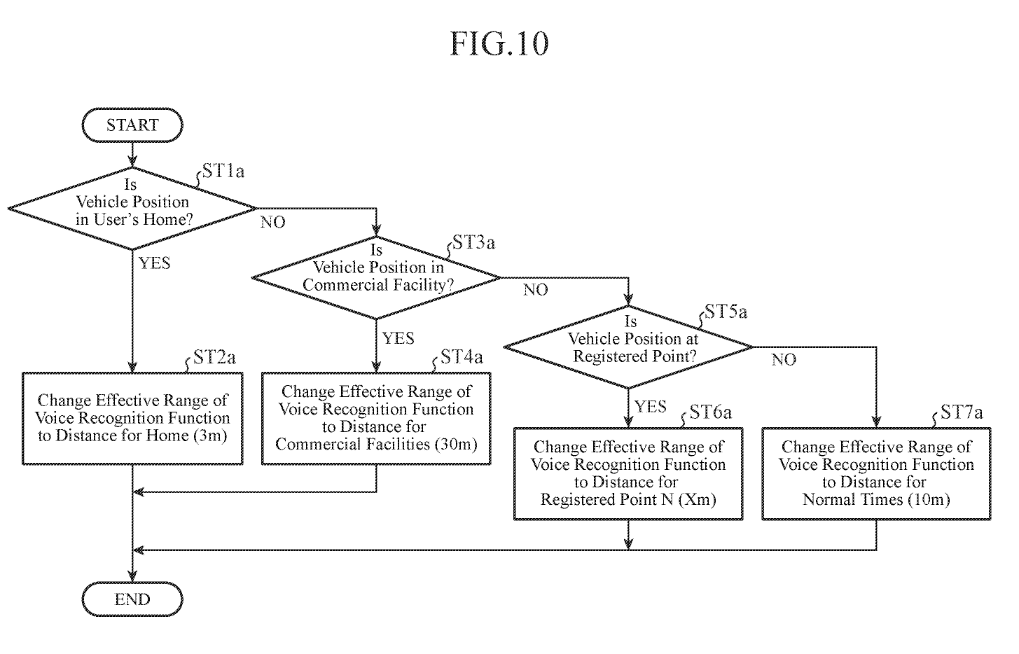

FIG. 10 is a flow chart of the process of changing the voice recognition enabled area in Embodiment 2. The position information manager changes the enabled distance on the basis of the distance inputted on the basis of the setting screen 9a of FIG. 9.

First, the position information manager 7 determines whether or not the parking position of the vehicle 20 is in the user's home on the basis of the current position information acquired from the GPS information provided by the GPS receiver 12 and the POI information read from the map DB 13 (step ST1a).

When the parking position of the vehicle 20 is in the user's home (when YES in step ST1a), the position information manager 7 changes the enabled distance to a distance for home (step ST2a). Here, the distance for home is one at which the voice recognition processor 6 is not enabled unnecessarily from the viewpoint of the positional relationship between the vehicle-mounted equipment 21 in the parking place and the mobile device 1. For example, the distance for home is 3 m.

When the parking position of the vehicle 20 is not in the user's home (when NO in step ST1a), the position information manager 7 determines whether or not the parking position of the vehicle 20 is in a commercial facility on the basis of the current position information and the POI information read from the map DB 13 (step ST3a).

When the parking position of the vehicle 20 is in a commercial facility (when YES in step ST3a), the position information manager 7 changes the enabled distance to the distance for commercial facilities (step ST4a). The distance for commercial facilities is one corresponding to a wider range in which the voice recognition processor 6 is enabled than the normal one. For example, the distance for commercial facilities is 30 m.

When the parking position of the vehicle 20 is not in any commercial facility (when NO in step ST3a), the position information manager 7 determines whether or not the parking position of the vehicle 20 is a registered point on the basis of the current position information and the POI information read from the map DB 13 (step ST5a).

When the parking position of the vehicle 20 is a registered point 1 (refer to FIG. 9) (when YES in step ST5a), the position information manager 7 changes the enabled distance to the distance for the registered point 1 (step ST6a). In the example of FIG. 9, because 20 m is set to the registered point 1, 20 m is set as the enabled distance. After that, when it is determined that the parking position of the vehicle 20 is a registered point 2 (refer to FIG. 9), the position information manager 7 changes the enabled distance to the distance for the registered point 2. In the example of FIG. 9, because 25 m is set to the registered point 2, 25 m is set as the enabled distance.

More specifically, the position information manager 7, in step ST5a, sequentially determines whether or not the parking position of the vehicle 20 is a registered point n, and, instep ST6a, sets, as the enabled distance, the distance (Xm) for the registered point n which is brought into correspondence with the registered point n at which the vehicle 20 is located.

When no registered point corresponding to the parking position of the vehicle 20 exists (when NO in step ST5a), the position information manager 7 changes the enabled distance to the distance for normal times (step ST7a).

In the example of FIG. 9, because 10 m is set at normal times, 10 m is set as the enabled distance.

As mentioned above, according to this Embodiment 2, the position information manager 7 can change the enabled distance range. By setting an appropriate enabled distance, the position information manager can set a range in which the mobile device can remotely perform an operation on the vehicle 20 at an appropriate timing without requiring the user's operation.

Further, according to this Embodiment 2, the position information manager 7 reduces the enabled distance range when the parking position is the restricted point which is determined in advance. By doing in this way, even if the parking position is in the user's home where its parking place is disposed closely, or the like, the enabling of the voice recognition processor 6 can be restricted appropriately.

In addition, according to this Embodiment 2, when the parking position is an allowable point which is determined in advance, the position information manager 7 enlarges the enabled distance range. By doing in this way, even if the parking position is in a commercial facility or the like where its parking place is disposed distantly, the enabling of the voice recognition processor 6 can be allowed appropriately. For example, even when a child runs towards the vehicle 20, the doors can be opened.

In addition, according to this Embodiment 2, the position information manager 7 changes the enabled distance range to the distance range specified by the user. By doing in this way, the enabled distance which the user desires can be set appropriately.

In addition, according to this Embodiment 2, the position information manager 7 automatically changes the enabled distance range. By doing in this way, the position information manager can set a range in which the mobile device can remotely perform an operation on the vehicle 20 without requiring the user's operation.

In addition, according to this Embodiment 2, the position information manager 7 automatically changes the enabled distance range to the distance range for the point corresponding to the parking position, the distance range being included in the distance ranges respectively registered for the plurality of points. By doing in this way, the position information manager can set a range in which the mobile device can remotely perform an operation on the vehicle 20 at an appropriate timing without requiring the user's operation.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the mobile device according to the present invention can suppress the occurrence of unnecessary communications and reduce the power consumption, the mobile device is suitable for, for example, a keyless entry system for vehicles.

### EXPLANATIONS OF REFERENCE NUMERALS

1 mobile device, 2 controller, 3 communication processor, 4, 34 vehicle state manager, 5 utterance voice generator, 6 voice recognition processor, 7 position information manager, 8, 35 authentication processor, 9 display, 10 speaker, 11 microphone, 12 GPS receiver, 13 map DB, 20 vehicle, 21 vehicle-mounted equipment, 22 ignition management ECU, door control ECU, 24 other control ECU, 31 remote operation controller, 32 outside-vehicle communication controller, 33 vehicle-mounted network communicator, 100 communication available area, 101, 101A, 101B voice recognition enabled area, 200 user's home, and 300 user.

1. A mobile device that transmits a remote operation request from a user to vehicle-mounted equipment and causes said vehicle-mounted equipment to perform an operation on a vehicle, the operation corresponding to said remote operation request, said mobile device comprising:
a position information manager to store, as a parking position, a position where said vehicle is keyed off;
a voice recognition processor to be enabled and perform voice recognition on the user's utterance when said mobile device and said vehicle-mounted equipment fall within an enabled distance range with respect to each other; and
a communication controller to transmit said remote operation request on which voice recognition is performed by said enabled voice recognition processor to said vehicle-mounted equipment.

2. The mobile device according to claim 1, wherein said communication controller starts communications with said vehicle-mounted equipment when triggered by the performance, by said voice recognition processor, of the voice recognition on said remote operation request.

3. The mobile device according to claim 1, wherein said position information manager can change said enabled distance range.

4. The mobile device according to claim 3, wherein when said parking position is a restricted point which is determined in advance, said position information manager reduces said enabled distance range.

5. The mobile device according to claim 3, wherein when said parking position is an allowable point which is determined in advance, said position information manager enlarges said enabled distance range.

6. The mobile device according to claim 3, wherein said position information manager changes said enabled distance range to a distance range specified by the user.

7. The mobile device according to claim 3, wherein said position information manager automatically changes said enabled distance range.

8. The mobile device according to claim 7, wherein said position information manager automatically changes said enabled distance range to a distance range for a point corresponding to said parking position, said distance range being included in distance ranges respectively registered for a plurality of points.

9. A vehicle remote control system in which a mobile device transmits a remote operation request from a user to vehicle-mounted equipment and causes said vehicle-mounted equipment to perform an operation on a vehicle, the operation corresponding to said remote operation request, wherein said mobile device comprises:
a position information manager to store, as a parking position, a position where said vehicle is keyed off;
a voice recognition processor to be enabled and perform voice recognition on the user's utterance when said mobile device and said vehicle-mounted equipment fall within an enabled distance range with respect to each other; and
a communication controller to transmit said remote operation request on which voice recognition is performed by said enabled voice recognition processor to said vehicle-mounted equipment, and wherein
said vehicle-mounted equipment comprises:
a vehicle side communication processor to receive said remote operation request from said mobile device; and
a remote operation controller to cause an operation on said vehicle to be performed, the operation corresponding to said remote operation request.

10. A vehicle remote control method of transmitting a remote operation request from a user to vehicle-mounted equipment, and causing said vehicle-mounted equipment to perform an operation on a vehicle, the operation corresponding to said remote operation request, said vehicle remote control method comprising:
storing, as a parking position, a position where said vehicle is keyed off;
being enabled and performing voice recognition on the user's utterance when a mobile device and said vehicle-mounted equipment fall within an enabled distance range with respect to each other;
transmitting said remote operation request on which voice recognition is performed to said vehicle-mounted equipment;
receiving said remote operation request from said mobile device; and
in a remote operation controller, causing an operation on said vehicle to be performed, the operation corresponding to said remote operation request.

11. (canceled)
